(19) United States
(12) Patent Application Publication
(10) Pub. No.: US 2026/0330649 A1
(43) Pub. Date: Oct. 22, 2026

(54) OBJECT TRACKING APPARATUS, CONTROL METHOD THEREFOR, AND STORAGE MEDIUM

(71) Applicant: CANON KABUSHIKI KAISHA, Tokyo (JP)

(72) Inventor: YUYA SASAKI, Tokyo (JP)

(21) Appl. No.: 19/646,737

(22) Filed: Apr. 14, 2026

(30) Foreign Application Priority Data
Apr. 21, 2025 (JP) 2025-069890

(51) Int. Cl. G06T 7/20; G06T 7/70; H04N 23/61

(52) U.S. Cl. CPC G06T 7/20; G06T 7/70; H04N 23/61

(57) ABSTRACT

An object tracking apparatus includes a first detection unit that detects motion of an image capturing apparatus, a first storage unit that stores motion information of the image capturing apparatus, a second detection unit that detects a position of an object from a captured image, a second storage unit that stores position information of the object, a prediction unit that predicts, in a case where a change is made from a first state to a second state, a correction amount for tracking the object in the second state, a first adjustment unit that adjusts the correction amount predicted by the prediction unit, and a control unit that controls a capturing range in the image capturing apparatus in the second state based on the correction amount adjusted by the first adjustment unit.

### BACKGROUND

### Field of the Technology

The present disclosure relates to a technology for tracking an object in an image capturing apparatus.

### Description of the Related Art

In recent years, many image capturing apparatuses each include an image blur correction apparatus that stabilizes image blur of a moving image caused by camera shake or the like. The image blur correction apparatus includes a unit that detects camera shake, and cancels the image blur by driving an image blur correction unit in response to a detected camera shake signal or cropping a smaller region from an image capturing region by image processing. The former is called optical image blur correction, and the latter is called electronic image blur correction.

When a moving image is recorded by an image capturing apparatus including the image blur correction apparatus described above, an object may go out of frame even if camera shake is corrected. This is because the image blur correction technology based only on the camera shake signal cannot correct the motion of the object. Therefore, in order to prevent a moving object from going out of frame, a photographer has been required to focus on framing while constantly paying attention to the motion of the object.

To the above problem, an object tracking apparatus that continues to track the object is effective. The object tracking apparatus controls and adjusts a viewing angle (capturing range) such that a desired object continues to be positioned near a predetermined position in a screen, and stabilizes the position of the object. This technology enables the photographer to perform capturing while stabilizing an object image even without continuing to concentrate on framing.

Japanese Patent Laid-Open No. 2021-96460 discloses a technology of estimating a target of interest from camera information and object information for an input image, synthesizing a viewing angle correction amount (object blur correction amount) and a camera shake correction amount based on the estimated target of interest, and performing image blur correction more desired by a user.

However, with the technology disclosed in Japanese Patent Laid-Open No. 2021-96460, the target of interest is estimated in consideration of the intention of the user and the viewing angle correction amount is generated, but the target of interest is merely selected from the object information. Therefore, correction cannot be performed in a case where the object disappears.

In a case where no object information is present, it is considered that no object is present in the screen, and the viewing angle correction amount is not generated. On the other hand, as a capturing scene, a situation is conceivable in which the object is temporarily hidden by an obstacle and appears again in the middle of capturing the object while following it. In this situation, in a case of knowing the position where the object appears again, the photographer moves the camera while predicting the position where the object is moving even though the object cannot be seen. At this time, by performing viewing angle correction control by predicting the object position even in a situation where there is no object, it is possible to keep the object near a predetermined position when the object appears again, and therefore it is possible to smoothly resume the viewing angle correction based on the object information, and the quality of the moving image is improved.

However, in a case where the prediction of the viewing angle correction amount is wrong, the object cannot be kept at the predetermined position even if the correction is performed, and conversely, the object may be separated from the predetermined position. In this case, there is a problem that the quality of the moving image may be degraded.

### SUMMARY

The present disclosure has been made in view of the above-described problems, and provides an object tracking apparatus that can perform object tracking with higher quality even in a case where an object temporarily disappears in the middle of tracking the object and the object appears again.

An aspect of the present disclosure, there is provided an object tracking apparatus comprising: at least one processor or circuit and a memory storing instructions to cause the at least one processor or circuit to perform operations of the following units: a first detection unit that detects motion of an image capturing apparatus; a first storage unit that stores motion information of the image capturing apparatus detected by the first detection unit; a second detection unit that detects a position of an object from a captured image captured by the image capturing apparatus; a second storage unit that stores position information of the object detected by the second detection unit; a prediction unit that predicts, in a case where a change is made from a first state in which the position information of the object is detected to a second state in which the position information of the object is not detected, a correction amount for tracking the object in the second state based on information stored in the first storage unit and the second storage unit in the first state and motion information of a camera in the second state; a first adjustment unit that adjusts the correction amount predicted by the prediction unit; and a control unit that controls a capturing range in the image capturing apparatus in the second state based on the correction amount adjusted by the first adjustment unit.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a configuration of an image capturing apparatus.

FIG. 2 is a block diagram illustrating a configuration related to image blur correction control and viewing angle correction control.

FIG. 3A is a flowchart showing object tracking amount calculation of a first embodiment.

FIG. 3B is a flowchart showing an operation of predicting a viewing angle correction amount.

FIG. 3C is a flowchart showing an operation of adjusting a predicted viewing angle correction amount.

FIG. 4 provides time-series graphs for predicting a viewing angle correction amount in the first embodiment.

FIG. 5 is a time-series graph for adjusting a predicted viewing angle correction amount in the first embodiment.

FIG. 6A is a flowchart showing object tracking amount calculation of a second embodiment.

FIG. 6B is a flowchart showing an operation of adjusting a viewing angle correction amount calculated based on object information.

FIGS. 7A and 7B are graphs showing viewing angle correction amount calculation based on object information in the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

In the present embodiment, a method will be described in which, in a case where an object cannot be detected (second state), a viewing angle correction amount (object blur correction amount) is predicted from camera information and object information stored in a case where the object can be detected (first state), and the predicted correction amount is adjusted and applied, whereby the object is appropriately tracked and the quality of a moving image is improved.

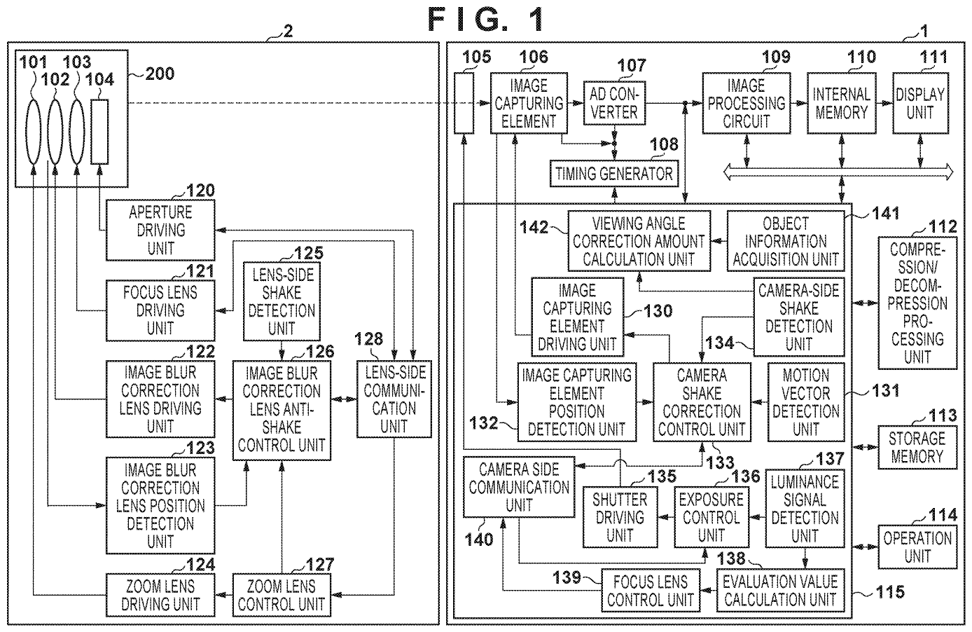

FIG. 1 is a block diagram illustrating a configuration of an image capturing apparatus that is the first embodiment of an object tracking apparatus of the present disclosure.

The image capturing apparatus is configured to include a camera body 1 and a lens unit 2.

A zoom lens 101 moves in an optical axis direction to optically change a focal length of an image capturing optical system (image capturing lens) 200 for forming an object image and change a field angle. By moving in a direction perpendicular to the optical axis, an image blur correction lens 102 optically corrects image blur caused by shake of the image capturing apparatus. By moving in the optical axis direction, a focus lens 103 optically adjusts a focus position. An aperture 104 and a shutter 105 can adjust the light amount by opening and closing, and are used for exposure control.

The light that has passed through the image capturing optical system 200 is received by an image capturing element 106 using a charge coupled device (CCD), a complementary metal oxide semiconductor (CMOS) sensor, and the like, and is converted from an optical signal to an electric signal.

An AD converter 107 performs noise removal processing, gain adjustment processing, and AD conversion processing on the image signal read from the image capturing element 106.

A timing generator 108 controls the drive timing of the image capturing element 106 and the output timing of the AD converter 107 in accordance with an instruction from a camera control unit 115.

An image processing circuit 109 performs pixel interpolation processing, color conversion processing, and the like on the output from the AD converter 107, and then sends the processed image data to an internal memory 110. The image processing circuit 109 includes an alignment circuit for a plurality of consecutively captured images, a geometric conversion circuit for performing cylindrical coordinate conversion and distortion correction of a lens group, and a synthesis circuit for performing trimming and synthesis processing.

A display unit 111 displays image capturing information and the like together with the image data held in the internal memory 110.

A compression/decompression processing unit 112 performs compression processing or decompression processing depending on an image format on the data stored in the internal memory 110.

A storage memory 113 stores various data such as parameters.

An operation unit 114 is a user interface for the user to perform various menu operations and mode switching operations.

A camera control unit 115 is constituted by a calculation apparatus such as a central processing unit (CPU), and executes various control programs stored in the internal memory 110 in response to a user operation by the operation unit 114. The control program is a program for performing, for example, zoom control, image blur correction control, automatic exposure control, automatic focusing control, control for tracking an object, and the like.

In a case of a lens-interchangeable camera, information transmission is performed between the camera and the lens by a camera-side communication unit 140 and a lens-side communication unit 128.

An aperture driving unit 120 performs driving of the aperture 104, and a shutter driving unit 135 performs driving of the shutter 105.

A luminance signal detection unit 137 detects, as luminance of the object and a scene, a signal read from the image capturing element 106 and passing through the AD converter 107. An exposure control unit 136 performs calculation of an exposure value (aperture value and shutter speed) based on the luminance information obtained by the luminance signal detection unit 137, and notifies the aperture driving unit 120 and the shutter driving unit 135 of the calculation result. The exposure control unit 136 also performs control to amplify the image signal read from the image capturing element 106 at the same time. Thus, automatic exposure control (AE control) is performed.

A zoom lens driving unit 124 drives the zoom lens 101 and performs change of the field angle. A zoom lens control unit 127 performs position control of the zoom lens 101 in accordance with a zoom operation instruction from the operation unit 114.

A focus lens driving unit 121 performs driving of the focus lens 103.

An evaluation value calculation unit 138 extracts a specific frequency component from the luminance information obtained by the luminance signal detection unit 137, and then calculates a contrast evaluation value based on it.

A focus lens control unit 139 issues an instruction to drive the focus lens 103 at a predetermined driving amount over a predetermined range. At the same time, it acquires an evaluation value that is a calculation result of the evaluation value calculation unit 138 at each focus lens position. By this, the defocus amount in the contrast AF method is calculated from the focus lens position where the change curve of the contrast evaluation value peaks, and is notified to the focus lens driving unit 121. Automatic focusing control (AF control) is performed in which a light flux is focused on the surface of the image capturing element 106 by being driven to the focus position by the focus lens driving unit 121.

Although the contrast AF method has been described here, a phase difference AF method may be used. Since the content of the phase difference AF method is known, the description will be omitted.

A shake detection unit includes, for example, an angular velocity sensor and an acceleration sensor, and detects shake applied to the image capturing apparatus. In the present embodiment, separately from a camera-side shake detection unit 134 disposed on the camera side, a lens-side shake detection unit 125 that detects vibration of shake applied to the lens is also disposed on the lens side.

An image blur correction lens position detection unit 123 detects the position of the image blur correction lens 102.

An image blur correction lens anti-shake control unit 126 calculates an image blur correction amount for suppressing image blur with respect to the shake detection signal detected by the lens-side shake detection unit 125, the camera-side shake detection unit 134, or both of them, and notifies the image blur correction lens driving unit 122 of the image blur correction amount. The image blur correction lens driving unit 122 performs control to drive the image blur correction lens 102 in a direction perpendicular to the optical axis.

A camera shake correction control unit 133 on the camera side can communicate with the image blur correction lens anti-shake control unit 126 via the camera-side communication unit 140 and the lens-side communication unit 128 in the image capturing optical system 200. The camera shake correction control unit 133 on the camera side calculates an image capturing element blur correction amount for suppressing image blur using the image capturing element 106 based on the shake detection signal detected by the camera-side shake detection unit 134, the lens-side shake detection unit 125, or both of them. Then, anti-shake by the image capturing element 106 is controlled by transmitting a driving signal of the image capturing element 106 to an image capturing element driving unit 130 based on the calculated correction amount and the position of the image capturing element 106 detected by an image capturing element position detection unit 132. The image capturing element driving unit 130 drives the image capturing element 106 in a direction perpendicular to the optical axis based on the image capturing element driving signal received from the camera shake correction control unit 133.

A motion vector detection unit 131 calculates a correlation value between the current frame and the previous frame in units of blocks in which a frame is divided by the block matching method. Thereafter, the block of the previous frame having the minimum calculation result is searched, and the shift of the other blocks relative to that block is detected as a motion vector.

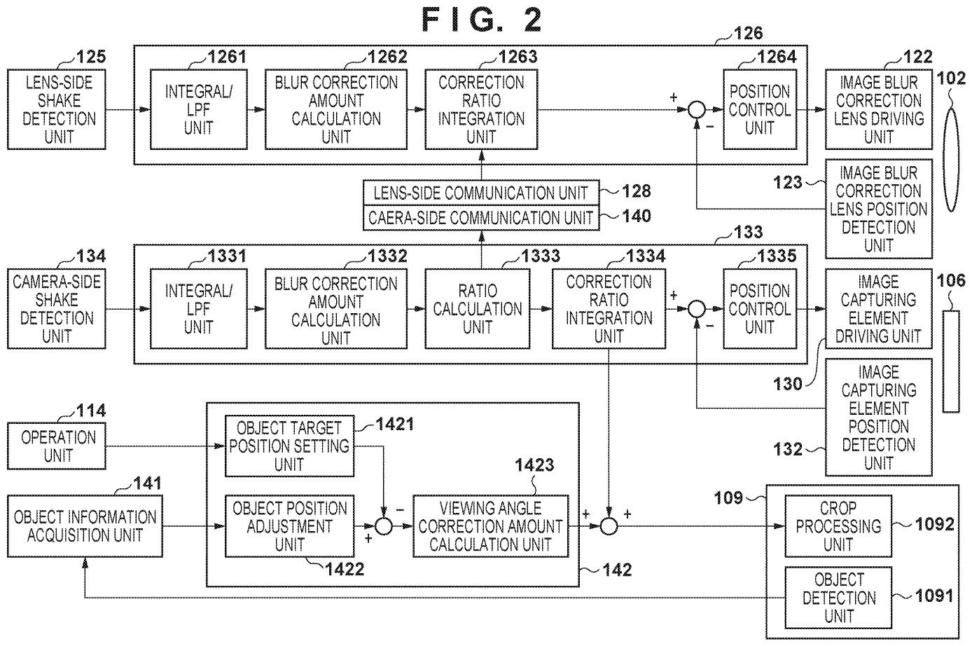

An object information acquisition unit 141 is a block that acquires information necessary for tracking amount calculation from the image processing circuit 109. A viewing angle correction amount calculation unit 142 calculates a viewing angle correction amount for correcting object blur. It is assumed that the viewing angle correction amount calculation unit 142 may acquire information directly from the image processing circuit 109 without passing through the object information acquisition unit 141. The object information acquisition unit 141 and the viewing angle correction amount calculation unit 142 will be described below with reference to FIG. 2.

FIG. 2 is a block diagram illustrating a functional configuration example related to image blur correction control and viewing angle (capturing range) correction control.

First, the camera shake correction control unit 133, which is an anti-shake control block on the camera side, will be described.

The shake angular velocity detected by the camera-side shake detection unit 134 is subjected to integration processing by a camera integration unit 1331, thereby converting it into a shake angle. Here, an integration low-pass filter (hereinafter, called an integration LPF) is used for the camera integration unit 1331.

A blur correction amount calculation unit 1332 calculates the correction amount for canceling the shake angle in consideration of the frequency band of the shake angle and the drivable range on the camera side. Specifically, calculation of the blur correction amount is performed by multiplying the shake angle by a gain related to the zoom magnification and the object distance.

A ratio calculation unit 1333 performs calculation of a correction ratio borne by the camera side when the total of the blur correction amounts on the camera side and the lens side is 100%. In the present embodiment, the correction ratio is determined based on the movable range of each of the image capturing element 106 and the image blur correction lens 102. The correction ratio may be determined in consideration of the movable range for the correction (electronic image blur correction) by cropping in image processing, other than the above-described correction member movable range. A correction ratio integration unit 1334 multiplies the blur correction amount by the calculation result in the ratio calculation unit 1333, and calculates the correction amount based on the correction ratio.

A position control unit 1335 performs PID control (proportional control, integration control, and differentiation control) on the deviation between the target position and the current position in the correction amount of the image capturing element 106, converts the deviation into an image capturing element driving signal, and inputs it to the image capturing element driving unit 130. The current position is an output result of the image capturing element position detection unit 132. Since PID control is a general technology, detailed description will be omitted. The image capturing element driving unit 130 drives the image capturing element 106 in response to an image blur correction driving signal.

Next, the image blur correction lens anti-shake control unit 126, which is an anti-shake control block on the lens side, will be described.

The shake angular velocity detected by the lens-side shake detection unit 125 is subjected to integration processing by a lens integration unit 1261, thereby converting it into a shake angle. Here, an integration LPF is used as the lens integration unit 1261. A blur correction amount calculation unit 1262 calculates the correction amount for canceling the shake angle in consideration of the frequency band of the shake angle and the drivable range on the camera side. Specifically, calculation of the blur correction amount is performed by multiplying the shake angle by a gain related to the zoom magnification and the object distance.

A correction ratio integration unit 1263 obtains the correction amount based on the correction ratio by multiplying the correction ratio borne by the lens side when the total of the blur correction amounts on the camera side and the lens side is 100%. In the present embodiment, it is assumed that the correction ratio borne by the lens side is obtained from the calculation result in the ratio calculation unit 1333 on the camera side. The correction ratios borne by the camera side and the lens side are notified via communication of the camera-side communication unit 140 and the lens-side communication unit 128.

A position control unit 1264 performs PID control (proportional control, integration control, and differentiation control) on the deviation between the target position and the current position in the correction amount of the image blur correction lens 102, converts the deviation into an image blur correction lens driving signal, and inputs it to the image blur correction lens driving unit 122. The current position is an output result of the image blur correction lens position detection unit 123. Since PID control is a general technology, detailed description will be omitted. The image blur correction lens driving unit 122 drives the image blur correction lens 102 in response to an image blur correction driving signal.

By driving the image blur correction lens 102 and the image capturing element 106 as described above, it is possible to reduce image blur due to camera shake.

Next, the image processing circuit 109 will be further described.

In the present embodiment, the image processing circuit 109 includes an object detection unit 1091. The object detection unit 1091 is a block that detects an image region of the object included in a captured image based on the image signal output from the image capturing element 106 and generates object detection information.

The object detection unit 1091 detects a person, an animal, or the like by image recognition, and calculates the position of the detection point. In detection processing in the object detection unit 1091, the shape of a contour part of a face or an entire body is stored inside as feature data, and an image region matching the feature data is specified by pattern matching processing for each image to be detected.

In face detection, an image region matching feature data representing the shape of the face stored inside in advance is specified by pattern matching processing from the region obtained by entire body detection. The matching score with the stored feature data is calculated, and a region having a predetermined matching score or more is set as a region of the face or the entire body. Then, pattern matching processing is performed using a plurality of pieces of feature data stored inside the image processing circuit 109 in order to increase detection opportunities of the face and the entire body and to enhance detection accuracy. The pattern matching processing may be performed using the feature data of only a part of the shape of the face or the entire body. In order to detect the face or the entire body regardless of the size thereof, the pattern matching processing may be performed while changing the size of the feature data.

As another detection method, detection by deep learning can also be performed. The object detection unit 1091 includes a plurality of multiply-accumulate operators and is also used as a block that performs deep learning. The object detection unit 1091 applies object detection processing to image data using one learning model selected by the camera control unit 115 among a plurality of stored learning models. The object detection unit 1091 may perform a plurality of types of detection processing by switching learning models for one piece of image data.

The object detection unit 1091 also performs object specification processing between images, such as object specification processing during live view. Upon detecting the object, the object detection unit 1091 temporarily stores an image of the region of the detected object as a template in the internal memory 110. Based on the template information temporarily stored in the internal memory 110, the object detection unit 1091 searches for a region matching the template temporarily stored in the internal memory 110 from within the image generated during live view to set the matching region as an object region.

As a method in which the object detection unit 1091 searches for a region matching the template temporarily stored in the internal memory 110, there is a method in which an image is cropped for each region, an absolute value of a difference from the template temporarily stored in the internal memory 110 is obtained, and the region having the smallest difference is set as the object region. There is another method in which the matching score of histogram, color data, and the like with the template temporarily stored in the internal memory 110 is obtained, and the object region is specified from the information. However, other methods may be adopted as long as a region matching the template temporarily stored in the internal memory 110 can be specified from the image.

In this manner, in the present embodiment, the object detection unit 1091 also functions as a unit that specifies a region from comparison between a plurality of images sequentially acquired by the image capturing element 106 based on a specific object detected from the image.

The image processing circuit 109 also includes a crop processing unit 1092 that performs electronic image blur correction. Here, a projective transformation method for electronic image blur correction to be performed in the crop processing unit 1092 will be described in detail. When the coordinates of each pixel in the image before correction are (X0, Y0) and the coordinates of each pixel in the image after correction are (X1, Y1), (Equation 1) is given as follows.

$$[ \begin{matrix}X 1 \\ Y 1 \\ 1\end{matrix} ] = [ \begin{matrix}h 1 & h 2 & h 3 \\ h 4 & h 5 & h 6 \\ h 7 & h 8 & 1\end{matrix} ] [ \begin{matrix}X 0 \\ Y 0 \\ 1\end{matrix} ] \qquad ( Equation 1 )$$

Here, the 3×3 matrix in (Equation 1) is generally called a projective transformation matrix. In this matrix, h1, h2, h4, and h5 represent blur correction amounts of rotation components, h3 and h6 represent blur correction amounts of translation components, and h7 and h8 represent blur correction amounts of tilt components. When (Equation 1) is transformed, (Equation 2) and (Equation 3) are obtained, and coordinates (X1, Y1) of each pixel in the image after correction can be calculated.

X1=(h1X0+h2Y0+h3)/(h7X0+h8Y0+1) (Equation 2)

Y1=(h4X0+h5Y0+h6)/(h7X0+h8Y0+1) (Equation 3)

When the angular shake amount in the pitch direction is θp, the angular shake amount in the yaw direction is θy, the angular shake amount in the roll direction is θr, the translation correction amount in the horizontal direction is tx, the translation correction amount in the vertical direction is ty, the tilt correction amount in the horizontal direction is vx, the tilt correction amount in the vertical direction is vy, and the focal length is f, elements h1 to h8 of the 3×3 matrix of (Equation 1) can be expressed as (Equation 4) to (Equation 11).

h1=cos θr (Equation 4)

h2=−sin θr (Equation 5)

h3=tx=f tan θy (Equation 6)

h4=sin θr (Equation 7)

h5=cos θr (Equation 8)

h6=ty=f tan θp (Equation 9)

h7=vx=−(tan θy)/f (Equation 10)

h8=vy=−(tan θp)/f (Equation 11)

In order to correct blur due to the angular shake θp in the pitch direction, the blur correction amount ty of the translation component in the vertical direction and the blur correction amount vy of the tilt component in the vertical direction are calculated from (Equation 9) and (Equation 11). In order to correct blur due to the angular shake θy in the yaw direction, the blur correction amount tx of the translation component in the horizontal direction and the blur correction amount vx of the tilt component in the horizontal direction are calculated from (Equation 6) and (Equation 10). In order to correct blur due to the angular shake Or in the roll direction, the blur correction amount in the rotation direction is calculated from (Equation 4), (Equation 5), (Equation 7), and (Equation 8).

The crop processing unit 1092 sets each of the elements h1 to h8 to perform projective transformation. By doing so, it is possible to correct each blur component, and therefore it is possible to perform electronic image blur correction.

Next, an object tracking control block will be described.

The object information acquisition unit 141 is a block that acquires object information detected by the object detection unit 1091 and acquires position information and the like.

The photographer can set a desired object as a tracking target object by performing touching or a button operation on the operation unit 114. The tracking target object may be determined by an automatic object setting program of the camera even without an operation by the photographer. With an object selected by the photographer or the camera as a main object, the object information acquisition unit 141 can acquire detection information related to the main object.

Based on the object detection information acquired from the object information acquisition unit 141, the viewing angle correction amount calculation unit 142 performs processing of changing the capturing range so that the object is stabilized at a predetermined position. The processing of changing the capturing range can also be performed by changing the cropping position of the image as in electronic image blur correction or by moving a housing. In the present embodiment, description is given on an assumption that the cropping position is changed by the crop processing unit 1092.

An object target position setting unit 1421 performs processing of setting a desired position within the capturing viewing angle as the object target position. The photographer can set the object target position via the operation unit 114. For example, the coordinates of the center of the viewing angle and the object target position arbitrarily set by the photographer are set. In the present embodiment, for easy understanding of the description, it is assumed that the object target position is the center of the viewing angle.

An object position adjustment unit 1422 extracts an object position, an object detection method, and the like from the object information acquired from the object information acquisition unit 141, and performs processing of adjusting the object position as necessary. In the present embodiment, the object detection information is acquired via the object information acquisition unit 141, but the information may be directly acquired from the object detection unit 1091 in the image processing unit 109.

A viewing angle correction amount calculation unit 1423 calculates the viewing angle correction amount in accordance with the object target position set by the object target position setting unit 1421 and the output of the object position adjustment unit 1422. As described above, since the object target position is the center of the viewing angle, the difference between the output of the object position adjustment unit 1422 and the center position of the viewing angle is calculated.

The viewing angle correction amount calculation unit 1423 further performs filter processing and performs processing of reducing noise related to the object position.

With the object tracking amount after the filter processing as an input, the crop processing unit 1092 of the image processing circuit 109 can perform object tracking by performing projective transformation processing. In a case where it is desired to perform the correction of the camera shake component and the object tracking in the crop processing unit 1092, both can be achieved by adding the object tracking amount to the blur correction amounts tx and ty of the translation component described above. The object tracking amount is also considered as necessary regarding the tilt correction amounts vx and vy.

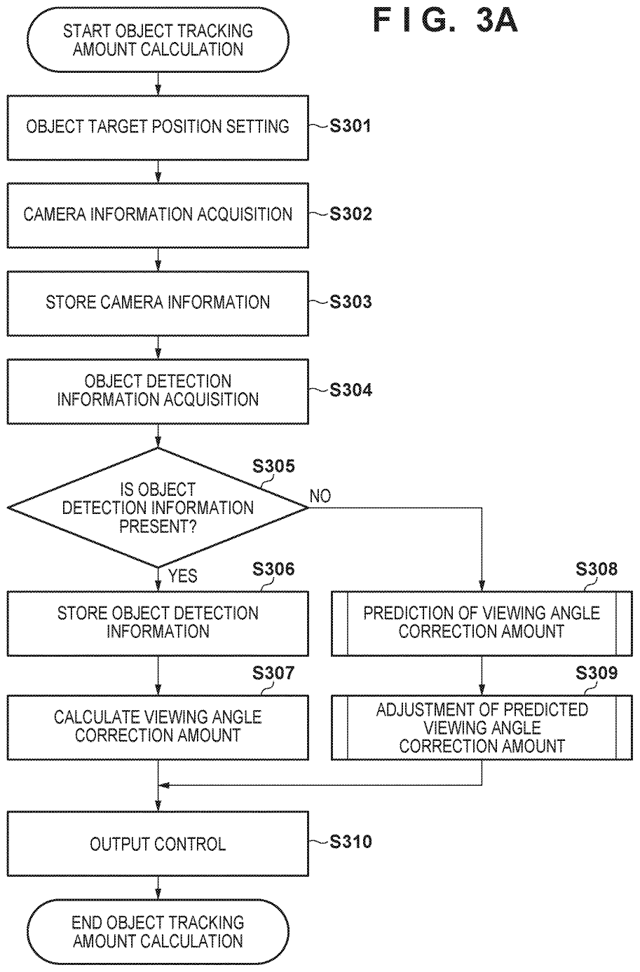

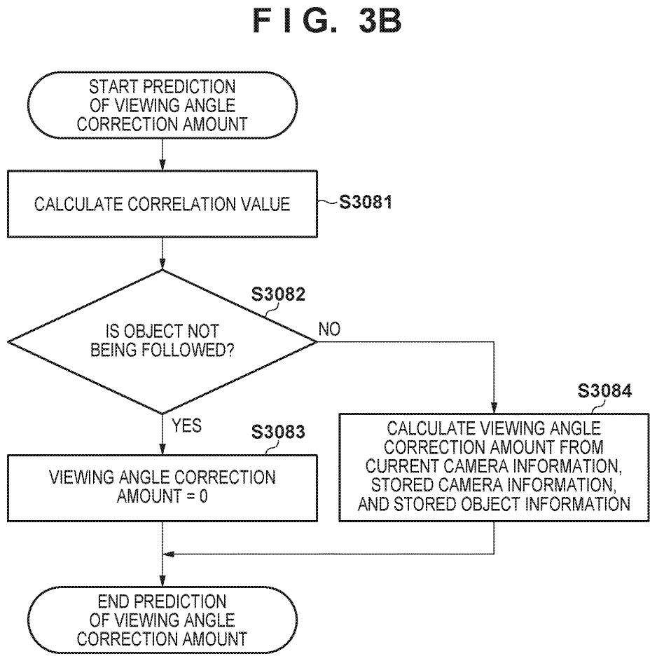

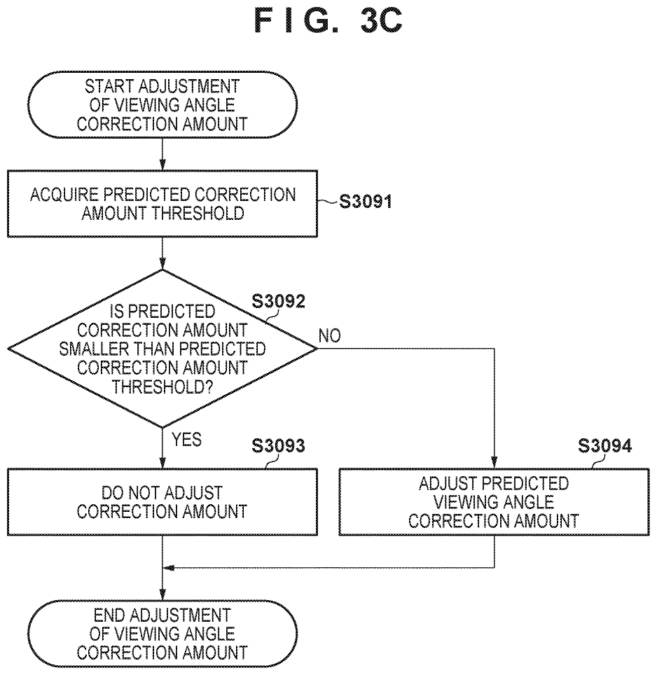

FIGS. 3A to 3C are flowcharts related to calculation of a viewing angle correction amount by prediction of the present embodiment. The processing of these flowcharts is basically executed in a cycle in which object detection is performed. The processing of these flowcharts is realized by the camera control unit 115 executing a control program stored in the internal memory 110.

FIG. 3A is a flowchart of object tracking amount calculation in the present embodiment.

First, in step S301, the camera control unit 115 sets an object target position. The object target position is set in advance by the photographer via the operation unit 114. The object target position does not need to be updated every time here unless reset by the photographer.

In step S302, the camera control unit 115 acquires the motion information of the camera. The motion information of the camera is information detected by the camera-side shake detection unit 134, and is information that shows how the camera is moved by the photographer.

In step S303, the camera control unit 115 stores the motion information of the camera acquired in step S302. The motion information of the camera is stored and retained in the storage memory 113. The storage period may be an arbitrary period, and a method in which a certain number or more of pieces of information are overwritten using a ring buffer may be adopted.

In step S304, the camera control unit 115 performs processing of acquiring object position information. As described above, based on the image signal output from the image capturing element 106, the object detection unit 1091 detects the image region of the object included in the captured image to generate object position information.

In step S305, the camera control unit 115 confirms whether or not the object information has been acquired in step S304. In a case where the object is not included in the captured image, object information cannot be acquired. The process proceeds to step S306 in a case where the object information has been acquired, and otherwise the process proceeds to step S308.

In step S306, the camera control unit 115 stores the acquired object information. The object information is stored and retained in the storage memory 113. Similarly to the camera information described in step S303, the storage period may be an arbitrary period, and a method in which a certain number or more of pieces of information are overwritten using a ring buffer may be adopted.

In step S307, the camera control unit 115 calculates a viewing angle correction amount. By obtaining a difference between the object position information included in the object detection information acquired in step S304 and the object target position set in step S301, a viewing angle correction amount for keeping the object at an arbitrary position is calculated.

In step S310, the camera control unit 115 performs adjustment of resolution, limit processing, and the like in order to input the viewing angle correction amount to a projective transformation circuit. By inputting the output of step S310 to the projective transformation circuit, the object can be kept positioned near the set object target position.

Returning to step S305, the operation in a case where the object is not found and the object detection information cannot be acquired will be described.

In step S308, the camera control unit 115 predicts the viewing angle correction amount. In a case where no object detection information is present, the position of the object is unknown. Therefore, what position the object was present at is predicted from the object detection information stored in step S306 in and before the last time, and how much the viewing angle correction should be performed is predicted from the camera information in steps S303 and S302, thereby calculating the viewing angle correction amount. Details of step S308 will be described with reference to FIG. 3B.

In step S3081 of FIG. 3B, the camera control unit 115 obtains a correlation value with reference to the camera information and the object detection information stored in steps S303 and S306. As the number of pieces of camera information and object detection information to be used for calculation of the correlation value, the number of pieces of information determined in advance from the stored information may be used, or the number may be changed in accordance with the intention by determining the user intention from the camera information.

In step S3082, the camera control unit 115 determines whether the photographer was following the object from the correlation value obtained in step S3081. In a case where the correlation value is smaller than a predetermined threshold, it is determined that the photographer was not following the object, and the viewing angle correction is not performed (step S3083). Otherwise, the viewing angle correction amount is calculated in step S3084.

In step S3084, a prediction formula is obtained with reference to the camera information and the object detection information stored in steps S303 and S306. As the number of pieces of camera information and object detection information to be used for calculation of the prediction formula, the number of pieces of information determined in advance from the stored information may be used, or the number may be changed in accordance with the intention by determining the user intention from the camera information. For the prediction formula, an approximate curve may be obtained, and an approximation using a polynomial of an arbitrary order is performed. The current camera information acquired in step S302 is applied to the obtained prediction formula, and prediction of the viewing angle correction amount is performed.

Returning to FIG. 3A, the camera control unit 115 performs adjustment of the correction amount in step S309 with respect to the viewing angle correction amount obtained by the prediction in step S3084 of FIG. 3B. This will be described in detail with reference to FIG. 3C.

In step S3091 of FIG. 3C, the camera control unit 115 acquires a correction amount threshold. This threshold may be a predetermined threshold or may be obtained cyclically with reference to the camera information or the object detection information.

In step S3092, the camera control unit 115 compares the threshold acquired in step S3091 with the viewing angle correction amount predicted in step S308, and determines whether the viewing angle correction amount exceeds the threshold. In a case of not exceeding the threshold, the correction amount is considered to be within a predetermined range, and in step S3093, the camera control unit 115 does not adjust the correction amount and ends the adjustment of the viewing angle correction amount. In a case where the viewing angle correction amount exceeds the threshold, it is determined that the appearance of the moving image may be deteriorated conversely if the viewing angle correction is performed according to the correction amount, and the viewing angle correction amount is adjusted.

Returning to FIG. 3A, in step S310, the camera control unit 115 performs viewing angle correction based on the viewing angle correction amount after adjustment obtained in step S309. By this, even in a case where no object detection information is present, the position where the object is expected to exist is adjusted to a desired position in the viewing angle, and even in a case where the object detection information can be acquired again, the object can be tracked with less fluctuation in the viewing angle, whereby the quality of the moving image can be improved.

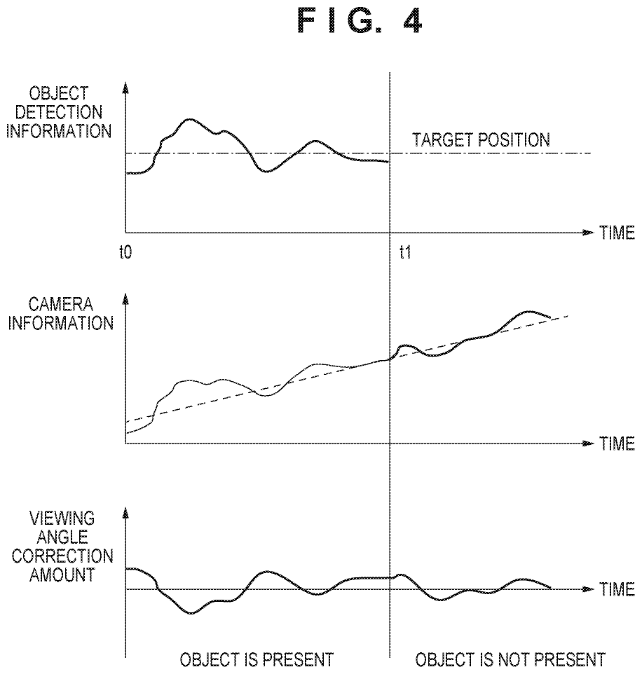

FIG. 4 provides time-series graphs showing the prediction of the viewing angle correction amount performed in step S3084 of FIG. 3B. From the top, they are a time-series graph of the object detection information, a time-series graph of the camera information, and a time-series graph of the viewing angle correction amount. It is assumed that in each of them, the horizontal axis indicates time, and represents the same time.

The object detection information can be acquired from time t0 to time t1, and the object detection information and the camera information so far are stored in the storage memory 113. While the object detection information can be acquired, the viewing angle correction amount is calculated based on the object detection information. The viewing angle correction amount is set such that the object is positioned at the target position indicated by the one-dot chain line.

After time t1, the object detection information cannot be acquired because the object is hidden by an obstacle. In this case, prediction is performed from the stored camera information. In FIG. 4, the prediction is performed by the least-squares method. The obtained formula is represented by the dotted line. Although FIG. 4 shows graphs of linear expressions, the prediction method is not limited to this, and an nth-order expression may be used.

By the prediction, the camera information in a case where the object is ideally being followed can be known. Therefore, by obtaining the difference between the currently acquired camera information and the camera information known from the prediction, it is possible to obtain the viewing angle correction amount in a situation where an attempt is made to continuously follow the object. The final viewing angle correction amount is calculated based on the last position information of the stored object detection information.

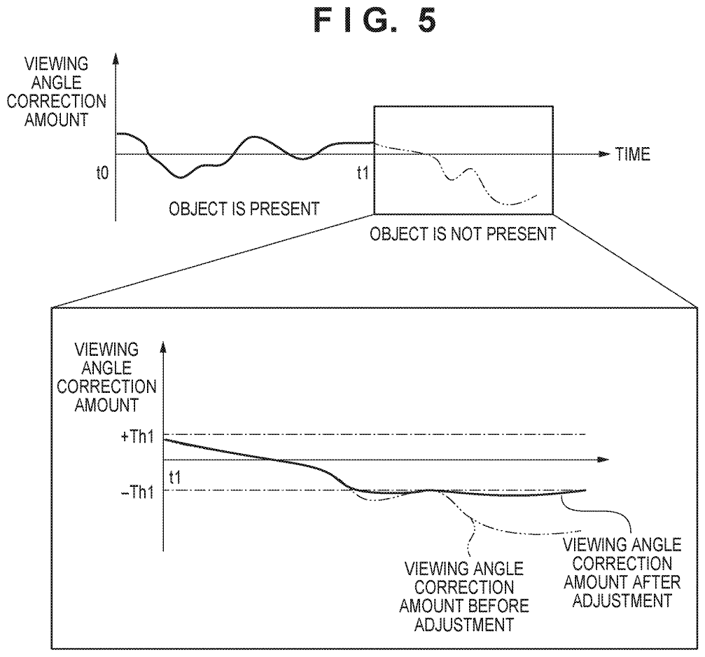

FIG. 5 is time-series graphs showing the adjustment of the predicted viewing angle correction amount performed in step S3094 of FIG. 3C. The upper graph is a time-series graph of the viewing angle correction amount of FIG. 4. The lower graph is a graph showing a case where regarding the correction amount predicted and calculated at and after time t1, the range surrounded by the square is enlarged and adjustment is performed.

The part surrounded by the square in which the viewing angle correction amount is obtained by prediction will be described.

Th1 is a threshold for determining whether or not to perform adjustment. The graph indicated by the two-dot chain line in the drawing is a viewing angle correction amount obtained by prediction and adjustment is performed in a case where the viewing angle correction amount has a value exceeding the range of a threshold±Th1. In a case where the viewing angle correction amount exceeds the threshold, a gain is applied to the viewing angle correction amount to perform adjustment in a direction of weakening the correction. The solid line indicates the correction amount after adjustment, and it can be seen that the value after adjustment is smaller than the value exceeding the threshold Th1.

The threshold and the amount to be adjusted may be determined in advance, or may be calculated from the stored camera information. They may be variable, or may be changed over time, for example.

A method of determining the threshold and the amount to be adjusted based on the movable range of the correction member is also conceivable. In the optical image blur correction, the correction effect is more easily exhibited when the correction member is at the center position. In the electronic image blur correction, the more the cropping region is at the center of the image capturing region, the more easily the correction effect is exhibited. This is because blur correction in various directions can be performed when the correction member is positioned at the center. In a case where the correction member is shifted to one side, a case is conceivable where the correction range is insufficient even if the blur in the direction in which the correction member is shifted is to be corrected, and as a result, the correction cannot be performed. In consideration of this, in a case where object blur correction is performed by prediction, the viewing angle correction amount may be adjusted by limiting the movable range of the correction member in preparation for being able to acquire the object detection information again.

As described above, in the present embodiment, even in a case where the object is hidden, object tracking is performed by predicting the viewing angle correction amount for the object tracking and adjusting the predicted correction amount. This enables viewing angle correction for the object tracking even in a case where no object detection information is present, and as a result, it is possible to improve the quality of the moving image in a case where the object appears again.

### Second Embodiment

In the present embodiment, a method of reducing a fluctuation in the capturing viewing angle by adjusting the correction amount with respect to a calculated viewing angle correction amount when the object appears again (third state) and calculation of the viewing angle correction amount is resumed using the object detection information will be described.

During correction based on a predicted viewing angle correction amount, in a case where it is switched to a normal viewing angle correction based on object detection information, if the object detection information is away from the target position, the viewing angle correction amount also increases, and as a result, the capturing range sharply fluctuates, resulting in a moving image with degraded visual quality.

Therefore, after the object detection information cannot be acquired once, the object detection information can be acquired again, and when the normal viewing angle correction is performed, the fluctuation is reduced by adjusting the viewing angle correction amount accordingly.

Hereinafter, the second embodiment of the present disclosure will be described. The configuration of the image capturing apparatus is similar to that in FIGS. 1 and 2.

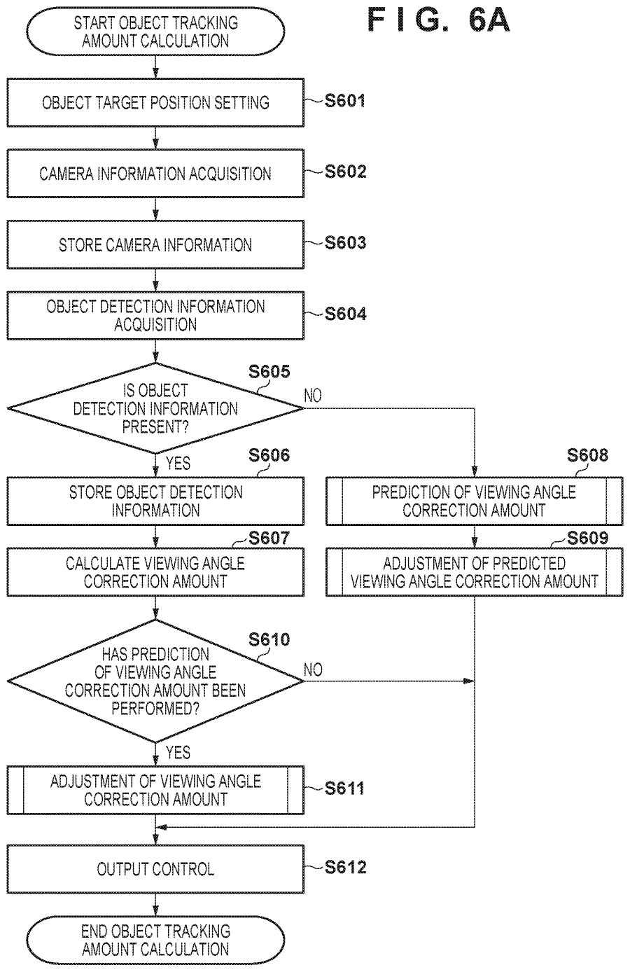

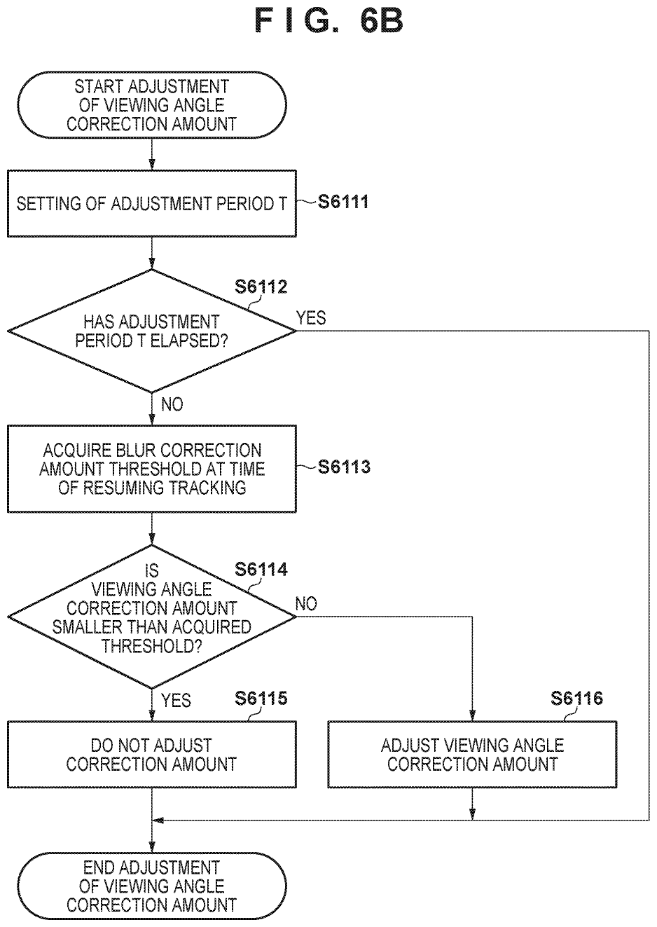

FIGS. 6A and 6B are flowcharts related to viewing angle correction amount calculation of the present embodiment. Hereinafter, FIG. 6A will be described.

Since steps S601 to S609 are similar to steps S301 to S309 of FIG. 3 in the first embodiment, the description will be omitted.

In step S610, in a case where the object detection information has been acquired, the camera control unit 115 determines whether or not the object detection information has been acquired up to the previous time. Since the prediction of the viewing angle correction amount is performed in a case where the object detection information cannot be acquired, it can be determined by confirming whether the prediction has been performed.

In a case where the prediction of the viewing angle correction amount has been performed, the camera control unit 115 adjusts the calculated viewing angle correction amount in step S611. Details of step S611 will be described with reference to the flowchart of FIG. 6B.

In step S6111 of FIG. 6B, the camera control unit 115 sets a period for adjustment. When the object detection is resumed and the calculation method for the viewing angle correction amount is changed, the quality of the moving image is improved by gradually switching to the viewing angle correction using the object detection information rather than switching immediately. Here, let the adjustment period be a period T determined in advance.

Note that in the present embodiment, the adjustment period is a constant, but may be determined in accordance with the image capturing cycle, or it is conceivable that a period in which object blur correction has been performed by prediction is stored and the adjustment period is set based on the period.

In step S6112, the camera control unit 115 determines whether or not the period set in step S6111 has elapsed. In a case where the period T has elapsed, it is switched to the viewing angle correction by the viewing angle correction amount using the object detection information, and therefore the subsequent processing is not performed and the adjustment is ended. In a case where the period T has not elapsed, the viewing angle correction amount is adjusted in order to perform switching of the moving image with high quality.

In step S6113, the camera control unit 115 acquires a threshold for determining whether to adjust the viewing angle correction amount calculated from the object detection information.

In step S6114, the camera control unit 115 compares the viewing angle correction amount calculated in step S607 with the magnitude of the threshold acquired in step S6113. In a case where the viewing angle correction amount does not exceed the threshold, it is determined that the appearance of the moving image is not deteriorated even if the correction is performed according to the calculated viewing angle correction amount, and the process proceeds to step S6115 and adjustment of the viewing angle correction amount is not performed.

In a case where the viewing angle correction amount exceeds the threshold, if the correction is performed with the calculated viewing angle correction amount, a sharp change in the capturing range is seen by the photographer, and it is considered that the quality of the moving image is deteriorated. Therefore, the process proceeds to step S6116 and adjustment of the viewing angle correction amount is performed.

Returning to FIG. 6A, in step S612, the camera control unit 115 can improve the appearance of the moving image by performing blur correction based on the viewing angle correction amount after adjustment that is obtained.

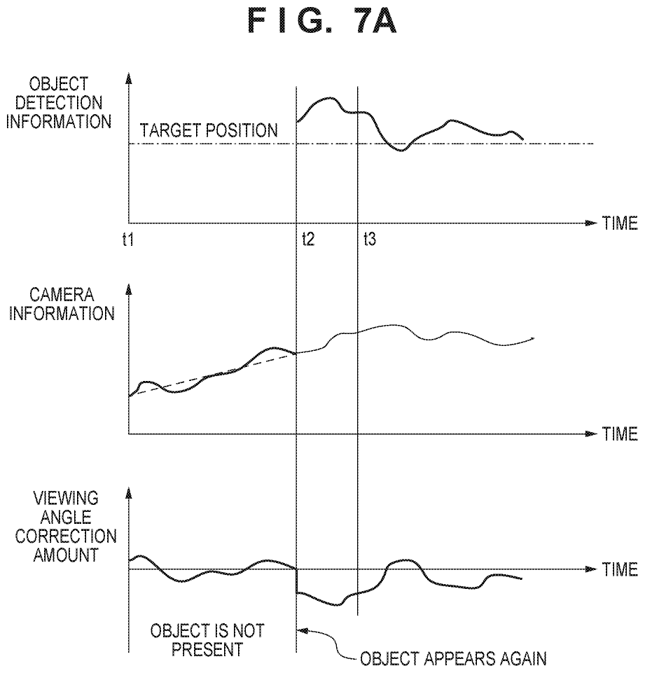

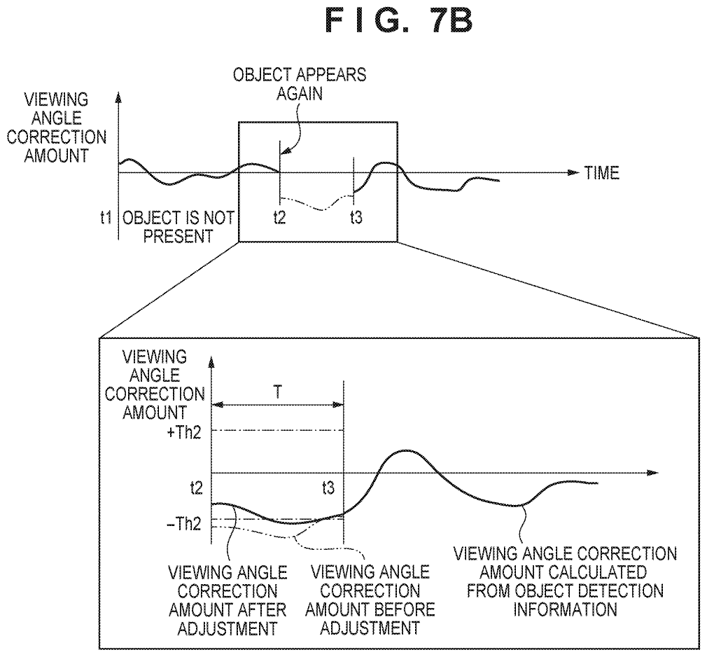

FIGS. 7A and 7B are time-series graphs showing the adjustment of the viewing angle correction amount performed in step S6116 of FIG. 6B. A time-series graph of the object detection information, a time-series graph of the camera information, and a time-series graph of the viewing angle correction amount are shown from the top of FIG. 7A. It is assumed that in each of them, the horizontal axis indicates time, and represents the same time. In FIG. 7B, the upper graph is a time-series graph of the viewing angle correction amount of FIG. 7A, and the lower graph is a graph showing a case where the viewing angle correction amount surrounded by the square from time t2 to time t3 is enlarged and adjustment is performed.

From time t1 to t2, the object detection information has not been acquired, and the viewing angle correction amount is calculated by predicting from the camera information. The object detection information can be acquired again at time t2, and the viewing angle correction amount is calculated from the object detection information. Note that the line indicated by the one-dot chain line in the graph of the object detection information is a graph of the target position, and the dotted line of the camera information graph is a graph of the prediction formula.

In a case where the object is shifted from the target position when the object detection information can be acquired again at time t2, the viewing angle correction amount is generated as in the lower graph of FIG. 7A. At this time, if correction is performed based on the calculated viewing angle correction amount, the capturing range moves sharply and the appearance of the moving image is deteriorated. Time t3 is a time indicating the end of a predetermined period. A period from time t2 to time t3 is the adjustment period T described with reference to FIG. 6B. The lower graph of FIG. 7B will be described focusing on this period.

In the lower graph of FIG. 7B, the two-dot chain line from time t2 to time t3 and the solid line from time t3 onward are the viewing angle correction amount calculated from the object detection information. At this time, the viewing angle correction amount exceeds a threshold Th2 between time t2 and time t3. Th2 is a threshold for determining whether or not to perform adjustment. In a case where the viewing angle correction amount exceeds the threshold, the viewing angle correction amount is adjusted in such a direction as to decrease the correction amount by applying a gain to the viewing angle correction amount. The solid line indicates the correction amount after adjustment, and it can be seen that the value after adjustment is smaller than the value exceeding the threshold Th2. By doing this, even if the viewing angle correction amount at the timing when the object detection information can be acquired is a large value, the motion gradually approaches the target position, and it is possible to suppress deterioration of the appearance of the moving image. After the period T elapses, the correction is performed based on the normal viewing angle correction amount.

Note that the threshold and the gain for adjustment may be determined in advance, or may be calculated from the stored camera information. They may be variable, or may be changed over time.

Note that in the above embodiment, an apparatus that tracks the object by performing the crop processing centering on a desired object with respect to an image capturing range has been described. However, the object may be tracked by driving the image blur correction lens or moving the image capturing element. A pan head or a gimbal configuration that can perform pan/tilt driving and a configuration that can move an optical element can also achieve a similar effect.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-069890, filed Apr. 21, 2025, which is hereby incorporated by reference herein in its entirety.

What is claimed is:

1. An object tracking apparatus comprising:
at least one processor or circuit and a memory storing instructions to cause the at least one processor or circuit to perform operations of the following units:
a first detection unit that detects motion of an image capturing apparatus;
a first storage unit that stores motion information of the image capturing apparatus detected by the first detection unit;
a second detection unit that detects a position of an object from a captured image captured by the image capturing apparatus;
a second storage unit that stores position information of the object detected by the second detection unit;
a prediction unit that predicts, in a case where a change is made from a first state in which the position information of the object is detected to a second state in which the position information of the object is not detected, a correction amount for tracking the object in the second state based on information stored in the first storage unit and the second storage unit in the first state and motion information of a camera in the second state;
a first adjustment unit that adjusts the correction amount predicted by the prediction unit; and
a control unit that controls a capturing range in the image capturing apparatus in the second state based on the correction amount adjusted by the first adjustment unit.

2. The object tracking apparatus according to claim 1, wherein in a case where the correction amount predicted by the prediction unit is larger than a first threshold, the first adjustment unit applies gain to the correction amount such that a value becomes smaller.

3. The object tracking apparatus according to claim 2, further comprising a setting device by which a user sets the first threshold.

4. The object tracking apparatus according to claim 2, further comprising a setting device that sets the first threshold based on the information stored in the first storage unit.

5. The object tracking apparatus according to claim 1, wherein the prediction unit predicts the correction amount based on an approximate curve of the motion of the image capturing apparatus obtained from a correlation between the information stored in the first storage unit and the information stored in the second storage unit.

6. The object tracking apparatus according to claim 1, further comprising:
a calculation unit that calculates the correction amount for tracking the object in a case where a change is made from the second state to a third state in which the position information of the object is detected; and
a second adjustment unit that applies gain to the correction amount calculated by the calculation unit such that a value becomes smaller for a certain period after the change to the third state.

7. The object tracking apparatus according to claim 6, wherein in a case where the correction amount calculated by the calculation unit is larger than a second threshold, the second adjustment unit applies gain to the correction amount such that a value becomes smaller.

8. The object tracking apparatus according to claim 1, further comprising a determination unit that determines whether a user is tracking the object.

9. The object tracking apparatus according to claim 8, wherein the determination unit determines whether the user is tracking the object based on a correlation between the information stored in the first storage unit and the information stored in the second storage unit.

10. The object tracking apparatus according to claim 1, wherein the control unit controls the capturing range by changing a cropping position of an image from the captured image.

11. The object tracking apparatus according to claim 1, wherein the control unit controls the capturing range by moving an image blur correction lens of the image capturing apparatus.

12. The object tracking apparatus according to claim 1, wherein the control unit controls the capturing viewing range by moving an image capturing element of the image capturing apparatus.

13. The object tracking apparatus according to claim 1, wherein the first detection unit includes an angular velocity sensor or an acceleration sensor.

14. A control method for an object tracking apparatus including a first detection unit that detects motion of an image capturing apparatus, a first storage unit that stores motion information of the image capturing apparatus detected by the first detection unit, a second detection unit that detects a position of an object from a captured image captured by the image capturing apparatus, and a second storage unit that stores position information of the object detected by the second detection unit, the control method comprising:
predicting, in a case where a change is made from a first state in which the position information of the object is detected to a second state in which the position information of the object is not detected, a correction amount for tracking the object in the second state based on information stored in the first storage unit and the second storage unit in the first state and motion information of a camera in the second state;
executing a first adjustment for adjusting the correction amount predicted in the predicting; and
controlling a capturing range in the image capturing apparatus in the second state based on the correction amount adjusted by the first adjustment.

15. A non-transitory computer-readable storage medium storing a program for causing a computer to execute each step of a control method for an object tracking apparatus including a first detection unit that detects motion of an image capturing apparatus, a first storage unit that stores motion information of the image capturing apparatus detected by the first detection unit, a second detection unit that detects a position of an object from a captured image captured by the image capturing apparatus, and a second storage unit that stores position information of the object detected by the second detection unit, the control method comprising:
predicting, in a case where a change is made from a first state in which the position information of the object is detected to a second state in which the position information of the object is not detected, a correction amount for tracking the object in the second state based on information stored in the first storage unit and the second storage unit in the first state and motion information of a camera in the second state;
executing a first adjustment for adjusting the correction amount predicted in the predicting; and
controlling a capturing range in the image capturing apparatus in the second state based on the correction amount adjusted by the first adjustment.
